(19) United States
(12) Patent Application Publication
(10) Pub. No.: US 2026/0008602 A1
(43) Pub. Date: Jan. 8, 2026

(54) RECYCLABLE POLYPROPYLENE-BASED STAND-UP POUCH

(71) Applicant: CAPRI SUN AG, Zug (CH)

(72) Inventor: Roland WEENING, Zug (CH)

(21) Appl. No.: 19/141,704

(22) PCT Filed: Oct. 13, 2023
(86) PCT No.: PCT/EP2023/078506

§ 371 Date: Jun. 20, 2025

(30) Foreign Application Priority Data
Dec. 20, 2022 (DE) 10 2022 134 007.4

(51) Int. Cl. B65D 75/00; B29D 22/00; B29K 23/00; B32B 1/00; B32B 7/02; B32B 7/05; B32B 7/12; B32B 27/08; B32B 27/32

(52) U.S. Cl. CPC B65D 75/008; B29D 22/003; B32B 1/00; B32B 7/02; B32B 7/05; B32B 7/12; B32B 27/08; B32B 27/32; B29K 2023/12; B29K 2995/0053; B29K 2995/0067; B32B 2255/10; B32B 2255/205; B32B 2307/306; B32B 2307/4023; B32B 2307/7244; B32B 2307/7246; B32B 2307/7376; B32B 2439/70

(57) ABSTRACT

A recyclable polypropylene-based stand-up pouch for drinks, having a front side, a rear side and a base, wherein the front side, the rear side and the base each have a transparent outer layer and a sealing layer, wherein the sealing layer has a greater thickness than the outer layer.

The invention relates to a recyclable stand-up pouch for beverages with a front side, a back side, and a bottom, where the front side, the back side, and the bottom each have a transparent outer coat and a sealing coat.

Stand-up pouches are flexible packaging that can stand on their bottom and are typically used for powders, pastes, or ready-to-drink beverages. The lower part of a stand-up pouch is provided with a side gusset to ensure the pouch's standing ability.

In 1963, Doyen disclosed a pouch with a bottom made of thermoplastic material in patent DE 1 281 140, consisting of two film coats connected by a W-shaped inward-folded bottom piece and welded together at their edges along the height of the pouch by longitudinal weld seams.

Stand-up pouches (SUPs) were first produced about 60 years ago. Early designs used a laminate of a layer of polyethylene terephthalate (PET) and a layer of polyethylene (PE). An aluminum foil layer could optionally be sandwiched therebetween. This type of design is still in commercial use, where a typical structure features a thin layer of approximately 12 μm of PET, a layer of approximately 8 μm of aluminum foil, and a thicker layer of approximately 80 μm of polyethylene. One problem with this SUP design is that the pouches are very difficult or impossible to recycle due to the different construction materials.

Stand-up pouches known today are used in practice as mass-produced items, where the typical structure of such film packaging pouches is also known, for example, from EP 2 032 454 B1 and EP 2 364 848 B1.

The material used for the bag wall is often a laminated composite bag film with an inner film made of polyethylene (PE) and an outer film based on polyethylene terephthalate (PET) or biaxially oriented polypropylene (BO-PP), where a printed layer for such a laminated composite is applied to the inside at the contact surface either onto the outer film or the inner film before the inner film is adhesively bonded to the outer film, and is then visible through the transparent outer film.

Such conventional film packaging bags are characterized by a particularly high-quality appearance and good functional properties. However, due to the lamination of the different polymer materials, pure plastic recycling is not possible, for which reason respective film packaging bags are usually landfilled or, at best, incinerated after use as disposable items, although thermal recycling is at least possible.

At the same time, the way in which plastic materials and therefore also packaging films, are currently produced and disposed of can be optimized. As part of its “Green Deal,” the European Union aims to reduce the landfilling of plastic waste. By 2030, 55% of plastic packaging waste is to be recycled.

To meet the challenges of recycling, packaging design must become increasingly sustainable. This can be achieved, for example, by implementing more monomaterial designs. The challenge here lies in achieving the very different properties of a piece of packaging with just one recyclable monomaterial design, which was previously achieved by combining different plastic layers with different material bases.

It has been shown that biaxially oriented polypropylene (BOPP) films, monoaxially oriented polyethylene (MDO-PE) films, and cast polypropylene films offer good rigidity and toughness for use in stand-up pouches and can then be configured to be thin.

WO 2021/156898 discloses a stand-up pouch made from a biaxially oriented polypropylene (BOPP) film. The BOPP film comprises at least one core layer made of a polypropylene-based material having an outer surface and an inner surface; an inner intermediate layer adjoining the inner surface of the core layer and made of a polypropylene-based material or a polyethylene-based material; an inner skin layer adjoining the inner intermediate layer and made of a polypropylene-based material or a polyethylene-based material and an outer skin layer corresponding to the outer surface of the core layer.

At the same time, the same mechanical properties of a multi-material design cannot be achieved, which presents new challenges for the design and construction of the stand-up pouch, affecting the dimensional stability and stand-up stability of the stand-up pouch. Due to the changing material properties, it is challenging to obtain the exact familiar and characteristic pouch shape.

Furthermore, commercially available stand-up pouches for beverages are filled and vacuum-sealed at temperatures above 85° C. A mono-material pouch design must be able to ensure the pouch's shape and the performance of the closing seal, even under hot-filling conditions.

The object of the present invention is to provide a recyclable stand-up pouch as a mono-material design that ensures the familiar typical shape of a stand-up pouch. In addition, the stand-up pouch is to meet the requirements of the Plastics Pact 2025 and be fully recyclable. The stand-up pouch is to protect the pouch contents from spoilage, ensure a long and flavorful shelf life, and provide a high barrier against the penetration of oxygen and water vapor. The stand-up pouch is to be sealable and suitable for hot-filling beverages. The flexible pouch packaging is to be safe for human health and ecologically sustainable. Furthermore, the stand-up pouch is to have a pleasant feel.

This object is satisfied according to the invention by a recyclable stand-up pouch, a method, and a use according to the independent main claims. Preferred variants can be gathered from the dependent claims, the description, the exemplary embodiment, and the drawings.

According to the invention, the sealing coat has a greater thickness than the outer coat.

The outer coat forms the outer skin of the stand-up pouch and is configured to be transparent in order to reveal and also to protect the printed image applied by counterprinting.

Advantageously, the outer coat is formed from a biaxially oriented polypropylene (BOPP), where the BOPP is formed to be stretched by a factor of more than 2.0, preferably by a factor of more than 3.0, in particular by a factor of more than 4.0, and/or is formed to be stretched by a factor of less than 7.0, preferably by a factor of less than 6.5, in particular by a factor of less than 6.0. The advantages of the outer coat in terms of good rigidity and toughness are therefore formed in an ideal manner, allowing a print image to be applied with repeat accuracy even to a particularly thin outer coat.

It is provided in one embodiment that the sealing coat is formed to be thicker than the outer coat by a factor of 2 to 4 or by a factor of 2.5 to 3.5. This achieves reliable sealing and using as little material as possible, while simultaneously ensuring sufficient pouch rigidity.

It can be provided that the outer coat is formed from BOPP and that the BOPP is formed to be stretched by a factor of more than 1.1 and of less than 2, in particular of more than 1.2 and of less than 1.8. This reduces the amount of material used while maintaining high flexibility and simultaneously ensuring rigidity.

In one embodiment, it is provided that the front side and/or the back side and/or the bottom have at least one functional coat arranged between the outer coat and the sealing coat, where the functional coat comprises metallized BOPP and where the metallized BOPP is formed to be stretched by a factor of more than 1.1 and of less than 2, in particular of more than 1.2 and of less than 1.8. This meets requirements regarding tightness and/or opacity while simultaneously using less material.

It can further be provided that the sealing coat is formed from cast polypropylene (CPP) and that the CPP is formed to be stretched by a factor of more than 3 and of less than 8, in particular of more than 4 and of less than 7. This ensures reduced material usage while maintaining a good sealing result.

Ideally, the thickness of the outer coat is more than 5 μm, preferably more than 10 μm, in particular more than 15 μm and/or less than 45 μm, preferably less than 40 μm, in particular less than 35 μm. The outer coat is therefore formed to be as thin as possible while simultaneously ensuring sufficient stability, which allows for the typical stand-up pouch shape to be obtained.

Ideally, the outer coat is formed to be multi-layered, where the outer coat has more than two layers, preferably more than three layers, in particular more than four layers.

For example, the outer coat has a polypropylene content of more than 92.5% by weight, preferably of more than 95% by weight, in particular of more than 97.5% by weight. This extremely high polypropylene content enables the stand-up pouch to be designed as a monomaterial stand-up pouch construction and makes it recyclable.

The inner side of the stand-up pouch is formed by a sealing coat.

In a particularly advantageous variant of the invention, the sealing coat is formed from a multi-layer cast polypropylene coat. The sealing coat is particularly advantageous for a sealing process.

Ideally, the thickness of the sealing coat is more than 45 μm, preferably more than 60 μm, in particular more than 75 μm and/or less than 125 μm, preferably less than 105 μm, in particular less than 85 μm. The sealing coat is therefore formed to be as thin as possible and simultaneously to ensure the sealability of absolutely tight seal seams.

Ideally, the sealing coat is formed to be multi-layered, where the sealing coat has more than two layers, preferably more than three layers, in particular more than four layers.

For example, the sealing coat has a polypropylene content of more than 92.5% by weight, preferably of more than 95% by weight, in particular of more than 97.5% by weight. This extremely high polypropylene content enables the stand-up pouch to be designed as a monomaterial stand-up pouch construction and makes it recyclable.

The outer coat and the sealing coat are preferably bonded with an adhesive layer and assembled into rectangular front side and back sides. The bottom of the stand-up pouch can, in principle, have the same structure. In an advantageous variant, the thicknesses of the outer coat and the sealing coat of the bottom are formed to be somewhat thinner. The front side, the back side, and the bottom of the stand-up pouch are connected by a sealing structure. The rectangular front and back sides are placed on top of each other, with a W-shaped folded bottom inserted therebetween.

In a particularly favorable variant of the invention, the sealing coat is formed to be thicker than the outer coat by a factor of more than 2.00, preferably by a factor of more than 2.25, in particular by a factor of more than 2.50. This achieves the advantageous sealability of the stand-up pouch, which is configured as a monomaterial design.

Ideally, the sealing coat is formed to be thicker than the outer coat by a factor of less than 6.50, preferably by a factor of less than 6,25, in particular by a factor of less than 6.00. A sealing coat that is too thick compared to the outer coat could adversely affect the sealing properties.

Heat sealing is the common method for creating seams in flexible stand-up pouches. The purpose of sealing is to join sealable materials together in an absolutely tight and secure manner. “Tight” specifically means impermeability to microbiological contamination as well as to the penetration of oxygen and water vapor, which are known to lead to the spoilage of food and hygroscopic contents in a stand-up pouch. The specific thickness and configuration of the cast polypropylene sealing coat as well as the sealing process itself achieve the required absolute tightness of the stand-up pouch.

Heat sealing uses two heated bars that apply pressure to the materials to be sealed and simultaneously conduct heat to the cut surface, whereby the materials melt and form a bond. The pressure ensures good contact between the materials and promotes the penetration of the molten viscous materials at the cut surface which, after cooling down, form a permanent and tight bond. Sealability is understood to be the successful and time-efficient process of joining the front side, the back side, and the bottom to form a stand-up pouch.

In an extremely advantageous variant of the invention, the front side and/or the back side and/or the bottom have at least one functional coat arranged between the outer coat and the sealing coat. The functional coat is preferably adhesively bonded between the outer coat and the sealing coat. The functional coat is configured as an ideal barrier against oxygen and water vapor. At the same time, it provides additional protection for the pouch against puncturing.

Ideally, the functional coat has a thickness of less than 25 μm, preferably of less than 20 μm, in particular of less than 15 μm, and/or of more than 6 μm, preferably of more than 9 μm, in particular of more than 12 μm.

The stand-up pouch according to the invention discloses a sophisticated monomaterial design based on polypropylene. Ideally, the stand-up pouch has a polypropylene content of more than 92.5% by weight, preferably of more than 95% by weight, and in particular of more than 97.5% by weight. This outstanding monomaterial design based on polypropylene provides advantageous recyclability and therefore complies with the requirements of the EU's “Green Deal.” The stand-up pouch according to the invention, with its thickness ratio of the sealing coat to the outer coat, realizes very different features that could previously only be achieved through a combination of materials and, at the same time, is particularly sustainable, in particular due to its recyclability.

Ideally, the functional coat has a barrier layer and/or a metallized layer and/or a metal layer and/or at least one BOPP layer.

In an advantageous variant, the functional coat is configured as a BOPP coat. A wafer-thin aluminum layer is vapor-deposited onto the BOPP layer. At the same time, the coat is prepared for adhesive lamination. This coat offers an exceptional barrier to oxygen, flavors, and aromas and has an excellent water vapor barrier.

In an advantageous variant of the invention, the BOPP coat is vapor-deposited, preferably vacuum-deposited. A metal layer, in particular an aluminum and/or aluminum oxide layer is there preferably vapor-deposited. The thickness of the metallized layer is more than 10 nm, preferably more than 15 nm, in particular more than 20 nm and/or less than 60 nm, preferably less than 50 nm, in particular less than 40 nm.

For example, the functional coat has a polypropylene content of more than 92.5% by weight, preferably of more than 95% by weight, in particular of more than 97.5% by weight. This extremely high polypropylene content enables the stand-up pouch to be designed as a monomaterial stand-up pouch construction and makes it recyclable.

Ideally, the metallized layer contributes to favorable reflection of UV light incident upon the stand-up pouch from the outside.

In an alternative variant, the functional coat is configured as an alternative barrier layer. The barrier layer is preferably applied between the sealing coat and the outer coat by plasma-assisted chemical vapor deposition.

The barrier layer deposited can preferably be formed from a silicon oxide. Alternatively or additionally, the barrier layer can be formed from an amorphous carbon layer. Furthermore, the barrier layer could be configured from a ceramic coating and/or an aluminum oxide.

The thickness of the alternative barrier layer is preferably 2 to 8 nm.

In a further alternative variant of the invention, the barrier layer can be configured as an ethylene-vinyl alcohol and/or polyvinyl alcohol layer.

In a completely different alternative of the invention, the barrier layer can be configured in the form of a printed primer layer. It can be configured, for example, from an ethylene-vinyl alcohol and/or polyvinyl alcohol layer and/or a polymer containing a carboxyl group. The barrier layer can there be applied either to the inner side or outer side of the outer coat or to the outer side of the sealing coat.

Preferably, the front side has an insertion system for inserting a drinking straw.

The stand-up pouch for beverages comprises an insertion system for inserting a drinking straw. The drinking straw comprises a tubular straw element comprising a straw wall, an inlet to be placed inside the stand-up pouch, and an outlet to be placed outside the stand-up pouch.

The straw element can be manufactured using an injection molding process. The cross-section of the straw element can be round, oval, triangular, or square.

Ideally, a packaging sleeve for the straw element, which ensures the hygienic closure of the straw element until the beverage is consumed, is formed by a thin transparent polypropylene coat. This polypropylene coat is affixed to the stand-up pouch in such a way that removal is very difficult. The packaging sleeve is easy to open to remove the straw element. The strong bond between the packaging sleeve and the stand-up pouch achieves effective recycling together.

The cross-sectional area of the insertion system and the cross-sectional area of the straw element, taking into account the wall thickness of the straw wall, can be similar, where the cross-sectional area of the insertion area can be 1% to 100%, in particular 30% to 70% larger than the cross-sectional area of the straw element, taking into account the wall thickness of the straw wall.

The printing process used for high-quality packaging is usually a serial printing process, such as gravure printing or flexographic serial printing.

The outer coat has a print which is preferably applied using reverse printing. The print can advantageously be applied as a translucent print or from the back side onto the inner side of the outer coat, thereby providing special protection for the printed image by the outer coat. The outer coat is printed onto in order to identify the brand and beverage ingredients as well as to create the visual impression of the beverage pouch.

A frequently used method for printing onto the outer coat is flexographic serial printing. This is a direct relief printing process, also known as a web-fed rotary printing process. The flexible printing plates, made of photopolymer or rubber, are used in combination with low-viscosity printing inks. The raised regions of the printing plate carry the image. The advantages are in the cost-effectiveness due to the utilization of a large printing width and high printing speed, as well as in the availability of inexpensive printing inks. The printing tools, the photopolymer printing plates, and/or the laser-engraved elastomer sleeves are readily available. Large print runs can be produced economically using flexographic printing.

In an alternative variant of the invention, a print can also be applied to the functional coat and/or to a metallized layer.

The permeability of films to gas is determined according to DIN EN ISO 2556 under atmospheric pressure. A film test specimen there separates two chambers, one of which contains the test gas at atmospheric pressure, while the air is evacuated from the other one with a known initial volume, until a near vacuum is obtained. The amount of gas flowing through the test specimen from one chamber to the other is determined as a function of time by measuring the pressure increase in the second chamber using a manometer.

The stand-up pouch advantageously has an oxygen transmission rate of less than 10 cm³/m². day. bar, preferably of less than 5 cm³/m². day. bar, in particular less than 0.1 cm³/m². day. bar, measured at 23° C. and 0% RH. This allows beverages to be stored for a long time in the stand-up pouch without artificial preservatives.

Permeability to water vapor is determined according to DIN 53116 using a gravimetric measurement method. A test container filled with a desiccant is sealed with a sample of a pouch film and exposed to a defined test climate. The amount of water permeating through the sample is determined by weighing. A quantity of water in the range of 1-200 g/(m2·d) can be detected. The detection limit also depends on the sample properties and the sample thickness.

Ideally, the stand-up pouch has a permeability to water vapor of less than 10 g/m², preferably of less than 5 g/m², in particular of less than 0.1 g/m² in 24 hours according to ASTM D6701-01. This allows for hot-filled liquids to be stored in the stand-up pouch for a long time with a long shelf life without the contents evaporating from the bag.

The film thickness was measured according to DIN 53370 and indicated as an average value. In an advantageous variant of the invention, the front side and/or the back side have a thickness of less than 180 μm, preferably of less than 160 μm, in particular of less than 140 μm, and/or of more than 80 μm, preferably of more than 90 μm, in particular of more than 100 μm. This makes the stand-up pouch be formed to be particularly thin and therefore lightweight, while still offering excellent durability.

In an advantageous variant, the thickness of the front side and/or the thickness of the back side is formed to be greater than the thickness of the bottom by a factor of more than 1.1, preferably by a factor of more than 1.2, in particular by a factor of more than 1.3, and/or greater than the thickness of the bottom by a factor of less than 2.0, preferably by a factor of less than 1.8, in particular by a factor of less than 1.6. The material usage can then be minimized. At the same time, the rigidity in the side surfaces required for the stable formation of the stand-up pouch can be ensured.

In a particularly advantageous variant of the invention, the sealing coat is formed from a multi-layer cast polypropylene coat. The sealing coat is particularly advantageous for a sealing process.

In an advantageous variant of the invention, at least one layer of the multilayer cast polypropylene coat contains a TiO₂ content.

The filler content can be determined using known measuring methods such as ashing. A sample with a known initial weight is heated to a temperature at which the polymer thermally decomposes, but the filler does not. For example, 560° C. has proven effective for this purpose. Thereafter, the sample weight is measured again. The polymer content per square meter can be calculated from the difference between the initial and the final weight.

As an alternative to ashing, a TGA measurement is possible, in which the weight of a sample is continuously measured during heating. This test method can also clearly differentiate between the polymer and the filler and allows the polymer content of the film to be determined.

In an advantageous variant of the invention, at least one layer of the multilayer cast polypropylene coat comprises an inorganic filler, where the filler content is more than 0.5% by weight, preferably more than 1.0% by weight, in particular more than 1.5% by weight.

Ideally, the filler is titanium dioxide, which allows a white layer with advantageous opacity to be obtained.

In a particularly advantageous variant, the filled layer of the sealing coat has an opacity according to DIN 53416 of more than 55%, preferably of more than 70%, in particular of more than 85%. This advantageously absorbs the light that is incident upon the stand-up pouch from the outside, thereby advantageously supporting the shelf life of the beverage in the stand-up pouch.

In a preferred variant, the innermost layer of the multilayer cast polypropylene coat in contact with the beverage is formed to be free of pigments, in particular free of titanium dioxide. This effectively prevents contact or even contamination of the beverage with pigments.

A particular challenge lies in the dimensional accuracy of the front side and the back side which are generally made from the same material, in particular from the same roll material. The future front and back sides are printed simultaneously onto a roll material of the outer coat and adhesively bonded to the functional coat and the sealing coat. Only with the special selection of materials and the special manufacturing process is it possible to produce such a dimensionally accurate outer coat that can be printed onto with very tight tolerances. The outer coat is characterized by a particularly small deviation in thickness per unit area.

Preferably, the front and back sides form a mirror-symmetrical structure with respect to the different coats. In an alternative variant of the invention, the coats can also be arranged differently.

In an alternative variant of the invention, the functional coat can, in principle, also be joined to the outer coat and the sealing coat by thermal lamination.

In an advantageous variant of the invention, the sealing coat comprises a content of antistatic agent. The antistatic agent can be selected from the group of substances consisting of glyceryl esters, fatty acids, tertiary amines, fatty acid amides, hydroxyl fatty acid amides, alkali metal sulfonates, polyether-modified polydiorganosiloxanes, polyalkylphenylsiloxanes, and/or mixtures thereof.

The sealing coat preferably contains an antistatic agent in an amount of 0.01 to 2% by weight of the coat, preferably of 0.1 to 1.5% by weight, and most preferably 0.4 to 1.0% by weight.

Since the coats are often stored in stacks or rolls prior to tailoring and sealing into stand-up pouches, migration of the antistatic agent could occur. Therefore, the outer coat can be equipped with an antistatic agent as a preventative measure.

In an advantageous variant of the invention, the front side, the back side, and the bottom of the stand-up pouch exhibit a shrinkage of less than 2.5%, preferably of less than 2.0%, in particular of less than 1.5%. This makes the front side, the back side, and the bottom particularly dimensionally accurate, even as the monomaterial design, enabling very precise printing. This dimensional stability is particularly advantageous for hot filling.

In an advantageous variant, the stand-up pouch, in particular the outer coat and/or the functional coat, exhibits a barrier against UV light in the wavelength range of 250-800 nm. The transmission is then less than 5%, preferably less than 3%, in particular less than 1%.

Overall, it is not trivial to fulfill the sum of these specifications with a monomaterial design. This can be achieved through the special combination of the selected individual coats configured as monomaterial or several multilayer materials and the special manufacturing method. Furthermore, the stand-up pouch can also be frozen and can also withstand the mechanical stresses associated therewith.

In a further variant of the invention, the outer coat has a heat-resistant coating. This coating can be configured, for example, in the form of a layer made of a mixture of an amorphous polyamide and a semi-crystalline polyamide. Such a coating provides an improved gas, in particular oxygen, barrier and in further embodiments can be provided with a thin metal or metal oxide layer, e.g., by way of a vacuum deposition process.

Advantageously, the heat-resistant coating increases the seal resistance of the outer coat and thereby also of the entire stand-up pouch by more than 10° C., preferably by more than 20° C., in particular by more than 25° C., compared to a pure polypropylene outer coat.

In other embodiments, the outer layer of the outer coat consists of at least 90% by weight, preferably of more than 95% by weight, of a mixture of an amorphous polyamide and a semi-crystalline polyamide. The outer layer of the outer coat preferably has a thickness of 2 to 4 μm. In this configuration, the outer layer of the outer coat is particularly advantageous in the production of the stand-up pouch because it is significantly less prone to sticking to the sealing jaws, through which the heat is conducted in order to form the seal lines on the front side, the back side, and the bottom of the stand-up pouch. It is to be noted that the polyamide, in its manageable proportions relative to the total mass of the stand-up pouch, has proven to be fully compatible with the concept of material recycling.

The front side, the back side, and the bottom of the stand-up pouch are connected by a sealing structure. The rectangular front side and back side are placed on top of each other, with a W-shaped folded bottom inserted therebetween, where the bottom preferably has punchings to create the vertical sealing lines.

The spatial terms refer to a filled and erected stand-up pouch.

Preferably, the horizontal sealing lines and the sealing lines with a contour are created first to connect the bottom to the front side and the back side. The sealing line with a contour overlaps the horizontal sealing line which preferably has curve from the center of gravity of the front side and the back side with a radius of R44 and then transitions to inclined sealing lines that extend to the upper bottom fold. Advantageously, the vertical sealing lines are performed last, also encompassing the folded bottom in the region of the punchings.

Ideally, the sealing lines have a width of 4 mm. The inner radii at the transitions from the vertical to the horizontal sealing line and/or at the transitions from the sealing lines with a contour to the vertical or horizontal sealing line are R1. In addition, the rounded corners on the outer side of the stand-up pouch preferably have a radius of R4.

In a further development of the invention, the vertical sealing lines have a width in the range of 4.1 to 5 mm.

To ensure increased stability, which is particularly advantageous when the stand-up pouch is constructed from monomaterial material or a layered structure of the individual coats, a transition structure is formed between the vertical sealing lines and the ascending sealing lines, which have a contour.

The sealed transition structure is characterized in particular by an enlarged sealing surface and provides the stand-up pouch with secure stand-up ability even with the monomaterial material design and increases the strength of the sealing seams, even under the effects of hot filling into the stand-up pouch. For this purpose, the transition structure has a special shape.

In a particularly advantageous variant of the invention, the transition structure has a vertical extension relative to the total length of the vertical sealing lines of more than 0.2%, preferably of more than 0.4%, in particular of more than 0.6%, and/or of less than 8%, preferably of less than 6%, in particular of less than 4%.

Ideally, the transition structure has a width relative to the vertical sealing line, where the width is more than 5%, preferably more than 10%, in particular more than 15%, and/or the width is less than 40%, preferably less than 35%, in particular less than 30%.

In a particularly preferred variant of the invention, the transition structure has the contour of a circle, of an ellipse, of a lens, of a long circle, of a rectangle, or of a square. The transition structure can overlap the vertical sealing line and/or the sealing line with a contour, whereby only part of the contour is additionally visible in the sealing structure. The transition structure ensures the typical bulbous shape of the stand-up pouch despite the altered mechanical properties of the monomaterial design.

Advantageously, the transition structure comprises a circular segment with a radius R that is oriented orthogonally to the circular segment, where the radius is greater than R2, preferably greater than R3, in particular greater than R4, and/or the radius is less than R30, preferably less than R25, in particular less than R20.

The radius of the circular segment can point outwardly or inwardly, when viewed from a top view onto the stand-up pouch.

Preferably, the front side and the back side of the stand-up pouch are connected by vertical sealing lines.

Preferably, the horizontal sealing lines and the sealing lines with a contour serve to connect the front side or the back side to the bottom of the stand-up pouch.

Ideally, the bottom is connected to the front side and the back side by vertical sealing lines and/or horizontal sealing lines and/or ascending sealing lines.

In a particularly advantageous variant of the invention, the vertical sealing lines have at least one reinforcing structure for producing a waisting of the pouch.

The reinforcing structure is preferably arranged in the upper half of the stand-up pouch.

In a particularly preferred variant of the invention, the reinforcing structure has the contour of a circle, of an ellipse, of a lens, of a long circle, of a rectangle, or of a square. The transition structure can there overlap the vertical sealing line.

In an advantageous variant of the invention, the sealed stand-up pouch is filled with a beverage having a temperature of up to 85° C. Immediately after the filling process, the stand-up pouch is sealed preferably with a horizontal ultrasonic weld. Alternatively, the stand-up pouch can also be sealed with a heat seal.

Ideally, in addition to the ultrasonic weld, a horizontal sealing line is formed to permanently close the stand-up pouch.

According to the invention, the method for the production of a stand-up pouch comprises extruding (or co-extruding or adhesively bonding if multiple layers are provided in the respective coat) the outer coat and the sealing coat, adhesively bonding the outer coat to the sealing coat, and connecting the front side to the back side and the bottom with a sealing structure to form a stand-up pouch. Ideally, the sealing coat is not adhesively bonded directly to the outer coat. In an advantageous variant of the invention, a functional coat is additionally adhesively bonded between the outer coat and the sealing coat. The sealing coat is formed with a greater thickness than the outer coat.

According to the invention, a stand-up pouch is used as a fully recyclable, polypropylene-based disposable beverage packaging for hot-filling beverages.

Further advantages and features of the invention shall become apparent from the description of an exemplary embodiment with reference to drawings and from the drawings themselves, where

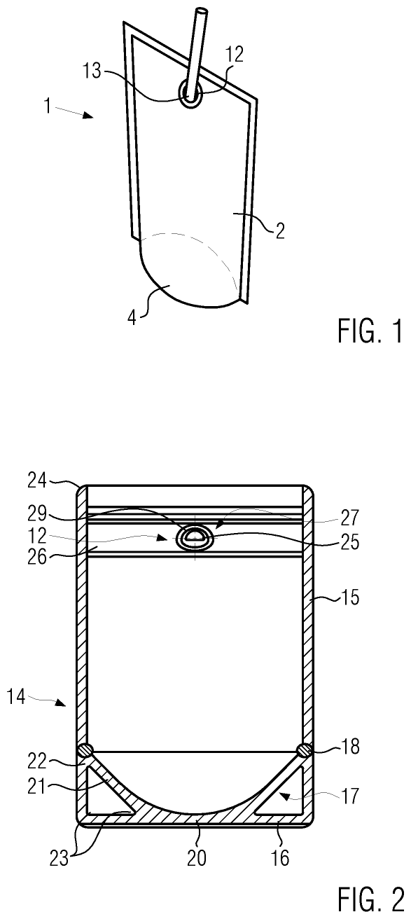

FIG. 1 shows a perspective view of a stand-up pouch,

FIG. 2 shows a view of the sealing structure and the insertion system,

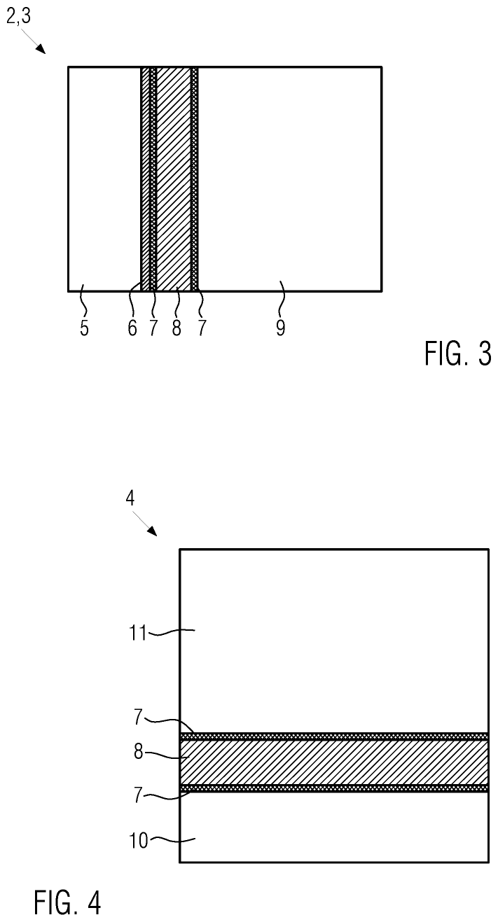

FIG. 3 shows a schematic view of the structure of the front side and the back side,

FIG. 4 shows a schematic view of the bottom structure.

FIG. 1 shows a perspective view of a recyclable stand-up pouch 1 for beverages with a front side 2, a back side, and a bottom 4. An insertion device 12, into which a drinking straw 13 is inserted, is arranged on front side 2.

FIG. 2 shows the sealing structure of stand-up pouch 1. For this purpose, front side 2, back side 3, and bottom 4 of the stand-up pouch are connected by a sealing structure 14. For this purpose, a W-shaped folded bottom 4 is inserted between rectangular front side 2 and rectangular back side 3.

Horizontal sealing lines 16 and the sealing lines with a contour 17 connect bottom 4 to front side 2 and to back side 3. The sealing line with a contour 17 has an overlap with horizontal sealing line 16 in the lower center of both front side 2 as well as back side 3. The sealing line with a contour 17, starting out from the center of gravity of front side 2 or back side 3, has a curve 20 with a radius of R44 and then extends in inclined sealing lines 21 that extend to upper bottom fold 22.

Vertical sealing lines 15 connect front side 2 to back side 3. In the region of bottom 4, punchings (not shown in the illustration) are arranged in the bottom to create vertical sealing lines 15, whereby sealing coats 9 of front side 2 and back side 3 have a contact surface to form the seal.

Sealing lines 15, 16, and 17 have a width of 4 mm. Inner radii 23 at the transitions from vertical sealing line 15 to the horizontal sealing line and/or at the transitions from the sealing lines with a contour 17 to vertical sealing line 15 or to horizontal sealing line 16 are R1. In addition, rounded corners 24 on the outer side of the stand-up pouch preferably have a radius R4.

To ensure increased stability, which is particularly advantageous when stand-up pouch 1 is constructed from monomaterial material, a transition structure 18 is formed between vertical sealing lines 15 and the sealing lines with a contour 17.

In the embodiment shown, insertion system 12 is formed from the combination of an opening 25 in the shape of a semicircular punch-out in front side 2 and strip 26 sealed on between front side 2 and back side 3 over vertical sealing line 15. Strip 26 additionally has a sealing shape 29 adapted to the punching.

FIG. 3 shows a schematic view of the structure of front side 2 and back side 3. A transparent outer coat 5 is arranged on the outer side of stand-up pouch 1, onto which a print 6 is applied using a counter-printing process. The inner side of stand-up pouch 1 is formed by a sealing coat 9. Outer coat 5 and sealing coat 9 are each bonded to a functional coat 8 by an adhesive layer 7.

In this embodiment, outer coat 5 consists of or comprises a BOPP and has a thickness of 30 μm. Sealing coat 9 is formed from or comprises cast PP and has a thickness of 80 μm. Functional coat 8 is formed of (or comprises) a BOPP with a vapor-deposited aluminum layer and has a thickness of 16 μm, a permeability to water vapor of less than 0.1 g/m² in 24 h, and a permeability rate to oxygen of less than 0.1 cm³/m² in 24 h.

FIG. 4 shows a schematic view of the structure of bottom 4. Outer coat 10 and sealing coat 11 are each bonded to a functional coat 8 by an adhesive layer 7. In this embodiment, outer coat 10 consists of or comprises a BOPP and has a thickness of 20 μm. Sealing coat 11 is formed from or comprises cast PP and has a thickness of 60 μm. Functional coat 8 is formed of (or comprises) BOPP with a vapor-deposited aluminum layer and has a thickness of 16 μm.

As already described, the invention is not restricted to a stand-up pouch with an outer coat, a functional coat (optionally provided), and a sealing coat, each consisting of only one material layer. Multiple material layers can also be provided in at least one of the outer coat, the sealing coat, and the functional coat (if provided).

For example, it can be provided in one embodiment that the outer coat comprises one or several layers of oriented PP, in particular BOPP, in accordance with the previously described embodiments in FIGS. 1 to 4. These layers can, but need not be of equal thickness and it can be provided, for example, that the outer coat (either the front side and/or the back side and/or the bottom) comprises two layers of oriented PP having the same layer thickness, comprises two layers of oriented PP having an unequal layer thickness, or comprises three or more layers of oriented PP having the same layer thicknesses or at least partially different, in particular different in pairs.

It can also be provided that one or several layers of the outer coat do not consist of oriented PP or comprise oriented PP, but instead comprise or consist of, for example, non-oriented PP. At least some of the layers of the outer coat can be, for example, co-extruded. Preferably, all layers of the outer coat are co-extruded together.

It can be provided in one embodiment that the total thickness of the outer coat is between 15 and 45 μm, in particular between 20 and 30 μm, preferably between 25 and 35 μm, in particular 18 or 20 or 24 or 28 or 30 or 32 or 34 μm. This thickness of the outer coat results in advantageous rigidity, which can advantageously influence the stand-up ability of the stand-up pouch.

The provision of an outer coat with the properties presently described results, firstly, in reduced thickness of the material layers for the front side and/or the back side and the bottom and therefore in reduced material usage, which has a beneficial effect on environmental compatibility. At the same time, using oriented PP, in particular BOPP, for the outer coat, for example, results in high tear resistance and/or stability against shrinkage of the pouch during sealing as BOPP has a comparatively high melting point of approximately 168° C. and therefore undergoes little to no deformation at lower sealing temperatures. Also, or alternatively, the use of respective materials can ensure high resistance to puncture holes (measured, for example, according to ISO EN 14477), which can improve the durability of the pouch.

In the direction of the internal volume of the stand-up pouch, a layer can be added which can optionally contain printing inks and can also be designed as an adhesive layer (also a first adhesive layer), for example, based on PUR-based adhesive. The printing ink can be incorporated into the adhesive or provided as an additional layer. The layer can comprise, for example, a layer thickness of less than 10 μm, preferably of less than 6 μm, for example, 5 μm or 4 μm or 3 μm, and can optionally be provided for connecting to an optionally provided functional coat of the front side and/or of the back said and/or of the bottom of the stand-up pouch. Alternatively, this layer (if the functional coat is not provided) can also form a direct connection with the sealing coat of the front side and/or of the back side and/or of the bottom of the stand-up pouch.

In embodiments in which a functional coat according to the preceding embodiments is provided, it can be applied to the side of the further layer (adhesive layer) facing away from the outer coat, where the first adhesive layer connects the outer coat and the functional coat to one another, and the functional coat can consist of or comprise, for example, one or more layers of oriented and/or non-oriented PP. Preferably, at least one of these layers is metallized, and particularly preferably, one of the oriented PP layers, in particular a BOPP layer, is metallized. This layer can, but need not have to be the outermost layer of the functional coat in the direction of the outer coat. For example, this layer can also (in a three-layer system of the functional coat) be arranged between two other layers without metallization, each of which can consist of or comprises oriented PP.

Overall, the thickness of this functional coat is preferably smaller than the thickness of the outer coat and in particular smaller than 90% or smaller than 75% of the thickness of the outer coat, preferably less than 60% of the thickness of the outer coat. For example, if the outer coat has a thickness of 30 μm, it can be provided that the thickness of the functional coat is 12, 14, 16, 18, or 20 μm. If the outer coat has a thickness of 22 μm or 20 μm, it can be provided that the thickness of the functional coat is 17 μm or 15 μm or 13 μm.

With these metallized functional coats, which are thinner as compared to the outer coat, improved barrier properties can be achieved with reduced material usage, for example with regard to tightness regarding the diffusion of gases, such as oxygen.

If the functional coat is provided, another layer (a second adhesive layer), comprising, for example, PUR-based adhesive, can be applied thereto in the direction of the interior volume of the stand-up pouch. Depending on the configuration of the overlying layers, this layer as well can contain one or more printing inks in the direction of the outer surface of the stand-up pouch, but this is not required. The thickness of the second adhesive layer can correspond to the thickness of the first adhesive layer between the outer coat and the optionally provided functional coat and can be, for example, equal in size, smaller, or larger. If the layer thickness of the first adhesive layer between the outer coat and the functional coat is, for example, 3 to 5 μm (e.g., 4 μm), then the layer thickness of the second adhesive layer adjoining the functional coat toward the sealing coat can be, for example, 2 to 4 μm, preferably 3 μm.

If no functional coat is provided, then the second adhesive layer can be the only layer of the stand-up pouch into which printing inks are incorporated.

The sealing coat adjoins this second adhesive layer in the direction of the interior volume of the stand-up pouch. As described, it can consist of a single layer of PP, optionally comprising additives such as titanium oxide (TiO₂). Alternatively, however, it can be provided that the sealing coat also comprises at least two, preferably at least three or more layers of PP. These layers can have the same layer thickness or have different thicknesses. Furthermore, they can all have the same structure (for example, consisting of PP homopolymer or PP copolymer, optionally with additives such as TiO₂, or BOPP or CPP. Or the individual layers of the sealing coat can also be configured differently.

For example, it can be provided that an outermost layer of the sealing coat facing in the direction towards the outer coat comprises PP homopolymer and optionally TiO₂, and a layer adjoining it in the direction towards the inner volume of the stand-up pouch consists of or comprises PP copolymer, or alternatively consists of or comprises BOPP or CPP. This can be again adjoined by a further layer of PP homopolymer (optionally comprising TiO₂) and/or PP copolymer and/or BOPP and/or CPP.

To advantageously influence the rigidity of the stand-up pouch and simultaneously ensure a high level of tightness of the stand-up pouch, it can be provided that at least two PP homopolymer layers with TiO₂ are arranged directly adjoining one another or consecutively in the direction of the outer coat of the stand-up pouch. They can be the two outermost layers (in the direction towards the outer coat) of the sealing coat and/or the two innermost layers (in the direction towards the internal volume of the stand-up pouch) of the sealing coat.

The layer thicknesses of the individual layers of the sealing coat do not have to be equal, but together they preferably have a layer thickness between 30 and 110 μm, particularly preferably between 80 and 100 μm, and particularly preferably between 85 and 95 μm. In general, the thickness of the sealing coat can be 100% to 300% the thickness of the outer coat. In an embodiment in which the thickness of the outer coat is 35, 30, or 20 μm, the thickness of the sealing coat can accordingly be 90 μm, 85 μm, 76 μm, 68 μm, or 55 μm. This thickness is particularly advantageous with regard to the low permeability to be achieved, for example, to oxygen or CO₂, through the front side or back side or the bottom of the stand-up pouch, and are at the same time sufficiently small to minimize material usage.

While the layers of the sealing coat can have the same layer thickness, it can be provided in particular that, for example, when the sealing coat is configured with three layers, the middle layer has the greatest layer thickness and, for example, consists of or comprises PP homopolymer with TiO₂. The layer thickness of this middle layer can be more than 50%, for example, 75%, or up to 65% of the total thickness of the sealing coat. For example, if the thickness of the sealing coat is 90 μm, then the layer thickness of the middle layer in a three-layer system can be, for example, between 45 and 57 μm, and in particular be 49, 50, 51, or 52 μm. Other combinations are also conceivable there. For example, if the thickness of the sealing coat is 68 μm, then the layer thickness of the middle layer can be, for example, 30 or 35 or 38 or 42 μm. For example, if the thickness of the sealing coat is 76 μm, then the middle layer can have a thickness of 40 or 42 or 45 μm. For example, if the thickness of the sealing layer is 55 μm, then the layer thickness of the middle layer can be 20 μm or 25 μm or 30 μm or 32 μm.

The second layer, when viewed from the middle layer facing in the direction toward the outer coat, can have up to 60%, preferably up to at most 45%, the thickness of the middle layer. For example, this layer can have a layer thickness of between 12 and 25 μm, in particular between 20 and 23 μm, for example 12, 14, 16, 18, 20, or 22 μm, and consist of or comprise PP homopolymer with titanium oxide. This layer thickness can generally be combined with any of the layer thicknesses of the middle layer stated above.

On the side of the middle layer facing the interior volume of the stand-up pouch, a third layer can be arranged (for example, another PP homopolymer or PP copolymer layer, optionally with TiO₂), whose layer thickness can be equal to the outer layer of the sealing coat or can be smaller than this layer thickness. In particular, the layer thickness of this inner layer can preferably be smaller than 50%, particularly preferably smaller than 40% of the layer thickness of the middle layer. If the layer thickness of the middle layer is, for example, 50 μm, then the layer thickness of the inner layer can be, for example, smaller than 25 μm, preferably smaller than 20 μm to 10 μm, and can be, for example, 16 or 17 or 18 μm. Other layer thicknesses can also be provided, for example, 11 μm or 14 μm, where all of the aforementioned layer thicknesses for the third layer can be combined with all embodiments of the middle layer and the second layer of the functional coat.

Providing a sealing coat with different layers, which can also have different layer thicknesses according to the above embodiments, has a beneficial effect on the sealing result and the tightness of the stand-up pouch. Providing three layers for the sealing coat also allows for the individual layers to be adapted to specific requirements, where providing the layers of the sealing coat from the same material (PP) can additionally ensure good recycling properties and internal stability of the sealing coat. The layer of the sealing coat facing the functional coat can advantageously improve the adhesion properties of the sealing coat to the functional coat. The middle layer of the sealing coat can advantageously improve stability within the specified layer thickness ranges (see above) and/or have a higher melting point than the innermost layer of the sealing coat to prevent excessive melting or liquefaction of the sealing coat. The innermost layer of the sealing coat, on the other hand, can have a reduced melting temperature (for example, between 70° C. and 110° C.), so that reliable sealing can be achieved, for example, to another inner layer of a sealing coat on another surface of the stand-up pouch. The layer thicknesses specified ensure that the surfaces of the pouch are reliably connected without the formation of holes or leaks.

The embodiments described generally apply for the outer coat, the functional coat, and the sealing coat on the front side as well as on the back side as well as the bottom of the stand-up pouch.

However, since the front side and the back side of the stand-up pouch are typically designed to stabilize the stand-up pouch, where the bottom of the stand-up pouch contributes little, the total thickness of the bottom (comprising the outer coat, the functional coat, and the sealing coat, as well as any intermediate layers) can be smaller than the total thickness of the outer coat, the functional coat, and the sealing coat, as well as any intermediate layers for the front side and the back side. For example, the thickness of the bottom, compared to the thickness of the front side or the back side, can be at most 80% of the thickness of the front side or the back side, or at most 75% of the thickness of the front/back side.

If the total thickness of the outer coat, functional coat, and sealing coat as well as any intermediate adhesive layers for the front side or the back side is, for example, 129 μm, then the total thickness of the bottom can be, for example, smaller than 100 μm, but preferably greater than 90 μm, in particular between 93 and 97 μm, particularly preferably 94, 95, or 96 μm.

In particular, when using the same layer structure, the outer coat can be configured to be thinner than the corresponding outer coat of the front side or back side and, for example, at a thickness of the outer coat of the front side or back side of 30 μm, can be only 18 μm, 19 μm, 20 μm, or 21 μm, but otherwise comprise the layer structure described above.

The functional coat can also, but need not, have a smaller thickness and at a thickness of the functional coat of the front side or back side of, for example, 16, 17, or 18 μm, can have a thickness of only 15 μm.

The sealing coat can also optionally, and independently of the thickness of the outer coat and the optionally provided functional coat, have a smaller thickness than the thickness of the front side or back side. If the thickness of the sealing coat on the front side or back side is, for example, approximately 80 μm, such as 76 μm, then the thickness of the sealing coat on the bottom can be, for example, smaller than 60 μm, in particular 54, 55, or 56 μm.

A correspondingly smaller layer thickness can then be selected for the individual layers of this sealing coat. For a total layer thickness of the sealing coat on the front side and the back side of 76 μm, with individual layers each having a thickness of 18, 43, and 16 μm (three-layer structure, for example, as described above), a total thickness of 55 μm can be provided for the sealing coat on the bottom, where, though the individual layers may have the same layer structure as for the side surfaces, they may only have a layer thickness of, for example, 14, 30, and 11 μm. The layer structure there can be, in particular, a three-layer structure with the properties specified above.

If, on the other hand, the layer thickness of the front or back side is, for example, 90 μm with a division into a three-layer system with layer thicknesses of 22, 50 and 18 μm and otherwise the structure described above, a layer thickness of only 60 to 75, for example 65 or 67 or 68 or 70 μm can be provided for the bottom, where, for example, at least three of the layers of the bottom (see above embodiments) can have layer thicknesses of e.g. 16, 38 and 14 μm.

While various embodiments of the outer coat, the functional coat, and the sealing coat, as well as of the first and second adhesive layers, have been described here, any combination of the individually specified layers of the respective outer coat, functional coat, and sealing coat, as well as of the first and second adhesive layers, is expressly also comprised.

The layers described can be used individually or in combination for stand-up pouches with an internal volume of at least 100 ml, or at least 200 ml, or at least 330 ml, or an intended filling of at least 100 ml, or 200 ml, or 330 ml of liquid. All embodiments described have advantageous stability and recyclability in this regard, while simultaneously being highly impermeable (including against the diffusion of gases such as oxygen). Any other volume is also possible. In particular, volumes of up to 500 ml, up to 1 l, or up to 2 l can be provided.

In the preceding embodiments, implementations for the material of the bottom and the side walls were described. In an embodiment, which can be provided in combination with all of the embodiments described, it is provided that the stand-up pouch is formed by joining three material surfaces: a front side, a back side, and a bottom. This makes it possible to meet different requirements for each of the material surfaces.

It can be provided in particular that the total thickness of the bottom is less than the total thickness of the side surfaces (front side and back side). In one embodiment, the total thickness of the side surfaces (front side and/or back side) is greater than the total thickness of the bottom by a factor of 1.1 to 2. This allows material to be saved while simultaneously producing a stable stand-up pouch, since the stability of the pouch is substantially obtained by the rigidity from the side surfaces.

Alternatively or additionally, it can be provided that the outer coat (of one or more of the side surfaces and/or the bottom) is formed from BOPP and where the BOPP is formed to be stretched by a factor of more than 1.1 and of less than 2, in particular of more than 1.2 and of less than 1.8. In this range, sufficient flexibility of the outer coat is obtained with simultaneously sufficiently high rigidity and the lowest possible material usage.

In connection with these embodiments (as already also escribed above) or alternatively, it can also be provided that the front side and/or the back side and/or the bottom have at least one functional coat arranged between the outer coat and the sealing coat, where the functional coat comprises metallized BOPP, and where the metallized BOPP is formed to be stretched by a factor of more than 1.1 and of less than 2, in particular of more than 1.2 and of less than 1.8. By providing such a functional coat, sufficient tightness and opacity can be achieved with simultaneously sufficiently high rigidity of the functional coat and low material usage.

It can further be provided that the sealing coat is formed from cast polypropylene (CPP) and where the CPP is formed to be stretched by a factor of more than 3 and of less than 8, in particular of more than 4 and of less than 7. This advantageously reduces the material use in the sealing coat, while simultaneously ensuring that sufficient CPP is available for reliable sealing.

The factors described so far for stretching the respective layers refer to a direction along the transport direction or the machine direction. Transverse to this direction, i.e., in a direction transverse to the transport direction, the stretch factor can be less than 1, in particular be between 0.2 and 0.8, preferably be between 0.3 and 0.8 for the outer coat and/or the functional coat. For the sealing coat, a factor in a direction transverse to the machine direction for compression can be between 2 and 15, preferably between 3 and 12.

1-22. (canceled)

23. A recyclable stand-up pouch for beverages, comprising:
a front side;
a back side; and
a bottom;
wherein:
the recyclable stand-up pouch is based on polypropylene;
each of the front side, the back side, and the bottom has a transparent outer coat and a sealing coat;
the sealing coat has a greater thickness than the outer coat.

24. The stand-up pouch of claim 23, wherein the sealing coat is thicker than the outer coat by a factor of more than 2.00.

25. The stand-up pouch of claim 23, wherein the sealing coat is thicker than the outer coat by a factor of less than 6.50.

26. The stand-up pouch of claim 23, wherein the sealing coat is formed to be thicker than said outer coat (5, 10) by a factor of 2 to 4 or by a factor of 2.5 to 3.5.

27. The stand-up pouch of claim 23, wherein at least one of the front side, the back side, and the bottom has at least one functional coat arranged between the outer coat and the sealing coat, wherein the functional coat has a thickness of less than 25 μm.

28. The stand-up pouch of claim 27, wherein the functional coat has at least one of a barrier layer, a metallized layer, a metal layer, and at least one BOPP layer.

29. The stand-up pouch of claim 27, wherein the functional coat has a vapor-deposited aluminum layer.

30. The stand-up pouch of claims 23, the outer coat has a print.

31. The stand-up pouch of claim 23, wherein the stand-up pouch has an oxygen transmission rate of less than 10 cm³/m²·day. bar, measured at 23° C. and 0% RH.

32. The stand-up pouch of claim 23, wherein the stand-up pouch has a permeability to water vapor of less than 10 g/m² in 24 hours according to ASTM 1 D6701-01.

33. The stand-up pouch of claim 23, wherein the front side and the back side have a thickness of less than 180 μm.

34. The stand-up pouch of claim 23, wherein the thickness of the front side and the thickness of the back side are greater than the thickness of the bottom by a factor of more than 1.1 and less than 2.0.

35. The Stand-up pouch of claim 23, wherein the thickness of the front side and the thickness of the back side are greater than the thickness of the bottom by a factor of more than 1.05 and less than 1.5.

36. The stand-up pouch of claim 23, wherein the outer coat is formed from BOPP stretched by a factor of more than 2.0 and less than 7.0.

37. The stand-up pouch of claim 23, wherein the outer coat is formed from BOPP stretched by a factor of more than 1.1 and less than 2.

38. The stand-up pouch of claim 23, wherein the front side, the back side, and the bottom (4) have at least one functional layer arranged between the outer coat and the sealing coat, wherein the functional layer comprises metallized BOPP stretched by a factor of more than 1.1 and of less than 2.

39. The stand-up pouch of claim 23, wherein the sealing coat is formed from cast polypropylene (CPP), and wherein the cast polypropylene (CPP) is stretched by a factor of more than 3 and of less than 8.

40. The stand-up pouch of claim 23, wherein the sealing coat is formed from a multilayer cast polypropylene coat.

41. The stand-up pouch of claim 23, wherein the front side, the back side, and the bottom exhibit a shrinkage of less than 2.5%

42. The stand-up pouch of claim 23, wherein the outer coat has a heat-resistant coating.

43. A method for production of a stand-up pouch, the stand-up pouch comprising a front side, a back side, and a bottom, each of the front side, the back side, and the bottom has a transparent outer coat and a sealing coat, the method comprising:
extruding the outer coat and the sealing coat;
adhesively bonding the outer coat to the sealing coat,
welding the front side to the back side and the bottom to form the stand-up pouch;
wherein the sealing coat is formed to have a greater thickness than the outer coat.

44. The method for production of the stand-up pouch of claim 43, further comprising hot filling the stand-up pouch to make a fully recyclable disposable beverage packaging.
